(19) United States
(12) Patent Application Publication
(10) Pub. No.: US 2025/0191090 A1
(43) Pub. Date: Jun. 12, 2025

(54) SYSTEM AND METHOD FOR CONTROLLING CONTENT PRESENTED ON DISPLAYS OF FOOD VENDORS USING A MOBILE COMPUTING DEVICE

(71) Applicant: Robert Hanson, II, Mobile, AL (US)

(72) Inventor: Robert Hanson, II, Mobile, AL (US)

(21) Appl. No.: 18/974,740

(22) Filed: Dec. 9, 2024

Related U.S. Application Data
(60) Provisional application No. 63/608,172, filed on Dec. 8, 2023.

(51) Int. Cl. G06Q 50/12; G06F 3/14; G06Q 30/0251; G06Q 30/0601

(52) U.S. Cl. CPC G06Q 50/12; G06F 3/14; G06Q 30/0269; G06Q 30/0631

(57) ABSTRACT

A system and method for controlling displays of food vendors is provided. The system generally comprises one or more computing devices having user interfaces, processor operably connected to said one or more computing devices, display operably connected to said processor, and non-transitory computer-readable medium coupled to said processor and having instructions stored thereon. Users of the system may control content presented on displays of food vendors via their computing device, allowing users to display content as decided on by the user on the displays.

### CROSS REFERENCES

This application claims priority to U.S. Provisional Application Ser. No. 63/608,172, filed on Dec. 8, 2023, in which application is incorporated herein in its entirety by reference.

### FIELD OF THE DISCLOSURE

The subject matter of the present disclosure refers generally to a system and method for controlling displays of food vendors via a mobile computing device.

### BACKGROUND

The smaller form factor and lower cost of modern displays has allowed food vendors to incorporate them into their businesses. One draw for the incorporation of displays into the business models of food vendors is the ease of altering digital menus as opposed to altering more traditional, paper-based menus. When a food vendor uses traditional, paper-based menus, they may be discouraged from altering food products offered by their business since that may require a new menu to be printed, which can cost a significant amount of money. By contrast, digital menus are disseminated via displays and can be easily altered in the future should a menu change be required, allowing for greater flexibility in menu offerings while simultaneously saving money. This is particularly beneficial for food vendors who consistently update menus with new specials in order to entice customers to patronize their establishment. Additionally, digital menus can be animated in a way that draws the eye of potential customers, resulting in higher sales.

Another reason food vendors have begun using modern displays in their businesses is to provide entertainment for potential customers. A customer who is entertained is not only more likely to remain for longer and order more food but is also more likely to return to the business at a later date. Food vendors who specialize in entertaining customers using sporting events are particularly invested in using displays as a major part of their business model because a larger number of displays provides a platform for offering more sporting events for customers to enjoy. However, customers are often unable to choose which sporting event is presented on a display, resulting in frustration on the part of the customer. And requiring employees to change the various displays of an establishment is inefficient for the employee when their time would be better spent serving food to the customers. Further, some food vendors that use displays in their business model provide very little in the form of entertainment as the displays serve mainly as a way to disseminate a menu to customers. Nor do these food vendors offer much in terms of customer control of the displays, potentially resulting in a loss of income as customers not entertained will be less likely to return.

Accordingly, there is a need in the art for a system and method that enables customers to control displays of vendors via mobile computing devices for entertainment and food ordering purposes. Additionally, there is a need in the art for a system and method that allows customers to personalize what is presented via the displays of vendors. Further, there is a need in the art for a system that determines the locations of users on the premises of food vendors in order to assist with the service process.

### SUMMARY

A system and method for monitoring and controlling a plurality of devices in a food vendor setting is provided. In one aspect, the present invention is a system for managing one or more displays for a food vendor to balance menu windows with entertainment displays. In another aspect, the present invention is a system for storing user information such as preferences, purchase history, and entertainment information. In yet another aspect, the present invention is a method for tracking and controlling content on one or more displays about the premises of a food vendor. In still another aspect, the present invention is a method of utilizing machine learning to manage displays and make predictions about customer desires and preferences. Generally, the present invention is a system and method for food vendors and their customers to improve the food service experience by ensuring the most relevant displays are available to the customer.

The system includes a central control unit configured to communicate with and manage the plurality of devices. The central control unit comprises a processor and a memory storing instructions that, when executed, cause the processor to perform operations including: receiving status information from each of the plurality of devices; analyzing the received status information to determine operational states of the devices; generating control commands based on the determined operational states; and transmitting the control commands to the devices to adjust their operation. The system further comprises at least one display device communicatively coupled to the central control unit. The display device is configured to present a graphical user interface showing real-time status information for the plurality of devices. The graphical user interface may integrate menu and entertainment content alongside the device status information.

The system may include one or more of the following features. The central control unit may be configured to collect and analyze user interaction data with the graphical user interface. The system may employ artificial intelligence techniques to predict future device states or user preferences based on the collected interaction data and device status information. The central control unit may generate customized menu recommendations or entertainment content selections based on the AI predictions. The display device may comprise a touchscreen interface allowing direct user control of the devices. The system may include environmental sensors to monitor ambient conditions in the food vendor setting, with the central control unit analyzing sensor data to optimize device operations. Remote access capabilities may be provided to allow offsite monitoring and control of the devices.

The present invention is furthermore a method for managing devices in a food vendor environment is provided. The method includes: receiving, at a central control unit, status data from multiple connected devices; analyzing the status data to determine operational states; generating control commands based on the analysis; transmitting the commands to adjust device operations; and displaying real-time status information on a graphical interface that integrates menu and entertainment content. Preferably, the method may further include collecting user interaction data with the interface, applying AI techniques to predict future states or preferences, and generating customized content or device control recommendations. Environmental sensor data may be incorporated into the analysis and control processes. The method may enable remote monitoring and management of the connected devices.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 illustrates a system embodying features consistent with the principles of the present disclosure.

FIG. 2 illustrates a system embodying features consistent with the principles of the present disclosure.

FIG. 3 illustrates a system embodying features consistent with the principles of the present disclosure.

FIG. 4 illustrates a system embodying features consistent with the principles of the present disclosure.

FIG. 5 illustrates an example display user interface used to present a predefined pattern that may be used as part of a secondary security method.

FIG. 6 illustrates an environmental view of an exterior display of a food vendor, wherein a display user interface of said display comprises a plurality of display windows.

FIG. 7 illustrates an environmental view of an interior display of a food vendor, wherein a display user interface of said display comprises a plurality of display windows.

FIG. 8 illustrates an environmental view of a display of a charging/fueling station, wherein said charging/fueling station is associated with a food vendor, and wherein a display user interface of said display comprises a plurality of display windows.

FIG. 9 illustrates an environmental view of digital signage of a shopping center, wherein said shopping center is home to one or more food vendors, and wherein a display user interface of said digital signage comprises a plurality of display windows.

FIG. 10 illustrates the manner in which individual access to data may be granted or limited based on user roles and administrator roles.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For instance, a system “comprising” components A, B, and C can contain only components A, B, and C, or can contain not only components A, B, and C, but also one or more other components. The phrase “at least one of A and B” is used herein to mean “only A, only B, or both A and B.” The phrase “at least one of A or B” is used herein to mean “only A or only B but not both A and B” Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). As will be evident from the disclosure provided below, the present invention satisfies the need for a system and method capable of allowing users to control displays of a food vendor.

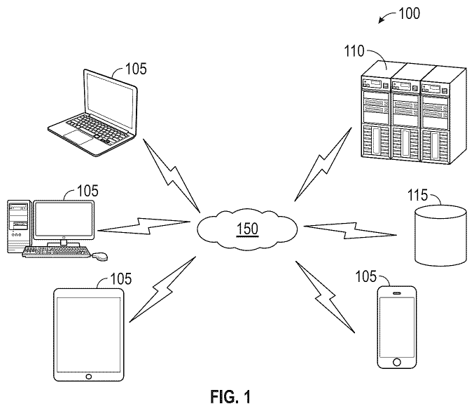

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network 150 may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a streaming device, a “smart” television, a personal digital assistant (PDA), a laptop, a smart phone, a tablet computer, or another type of computation or communication interface 280. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network 150, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server 110. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for instance, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages to users 405, wherein a provided webpage may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network 150. Document indexing servers may, for instance, store and index content, information, and documents relating to user accounts and user-generated content. Web servers may include servers 110 that provide webpages to clients 105. For instance, the webpages may be HTML-based webpages. A web server may host one or more websites. As used herein, a website may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

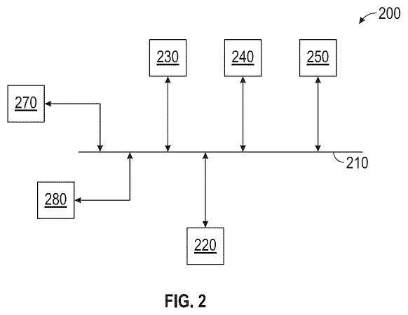

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280 (such as wired or wireless communication device). The bus 210 may be defined as one or more conductors that permit communication among the components of the computing entity 200. The processor 220 may be defined as logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communication between the two. A storage device 250 may be defined as a device used to provide mass storage to a computing entity 200. A communication interface 280 may be defined as any transceiver-like device that enables the computing entity 200 to communicate with other devices and/or computing entities 200.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces, applications 605 run by a computing entity 200, and wireless communication by a communication interface 280 of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers 110, mainframes, cellular telephones, tablet computers, smart televisions, streaming devices, or any other similar device. Accordingly, the inventive subject matter disclosed herein, in full or in part, may be implemented or utilized in devices including, but are not limited to, laptops, desktops, workstations, personal digital assistants, servers 110, mainframes, cellular telephones, tablet computers, smart televisions, streaming devices, or any other similar device.

Memory 304 stores information within the computing device 300. In some preferred embodiments, memory 304 may include one or more volatile memory units. In another preferred embodiment, memory 304 may include one or more non-volatile memory units. Memory 304 may also include another form of computer-readable medium, such as a magnetic, solid state, or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device and/or an output device. As used herein, an input device may be defined as a device that allows a user 405 to input data and instructions that is then converted into a pattern of electrical signals in binary code that are comprehensible to a computing entity 200. An input device of the peripheral device 270 may include one or more conventional devices that permit a user 405 to input information into the computing entity 200, such as a controller, scanner, phone, camera 905, scanning device, keyboard, a mouse, a pen, voice recognition and/or biometric mechanisms, etc. As used herein, an output device may be defined as a device that translates the electronic signals received from a computing entity 200 into a form intelligible to the user 405. An output device of the peripheral device 270 may include one or more conventional devices that output information to a user 405, including a display 316, a printer, a speaker, an alarm, a projector, etc. Additionally, storage devices 250, such as CD-ROM drives, and other computing entities 200 may act as a peripheral device 270 that may act independently from the operably connected computing entity 200. For instance, a streaming device may transfer data to a smartphone, wherein the smartphone may use that data in a manner separate from the streaming device.

The storage device 250 is capable of providing the computing entity 200 mass storage. In some embodiments, the storage device 250 may comprise a computer-readable medium such as the memory 304, storage device 250, or memory 304 on the processor 220. A computer-readable medium may be defined as one or more physical or logical memory devices and/or carrier waves. Devices that may act as a computer readable medium include, but are not limited to, a hard disk device, optical disk device, tape device, flash memory or other similar solid-state memory device, or an array of devices, including devices in a storage area network or other configurations. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as ROM 240, RAM, flash memory, and the like.

In an embodiment, a computer program may be tangibly embodied in the storage device 250. The computer program may contain instructions that, when executed by the processor 220, performs one or more steps that comprise a method, such as those methods described herein. The instructions within a computer program may be carried to the processor 220 via the bus 210. Alternatively, the computer program may be carried to a computer-readable medium, wherein the information may then be accessed from the computer-readable medium by the processor 220 via the bus 210 as needed. In a preferred embodiment, the software instructions may be read into memory 304 from another computer-readable medium, such as data storage device 250, or from another device via the communication interface 280. Alternatively, hardwired circuitry may be used in place of or in combination with software instructions to implement processes consistent with the principles as described herein. Thus, implementations consistent with the invention as described herein are not limited to any specific combination of hardware circuitry and software.

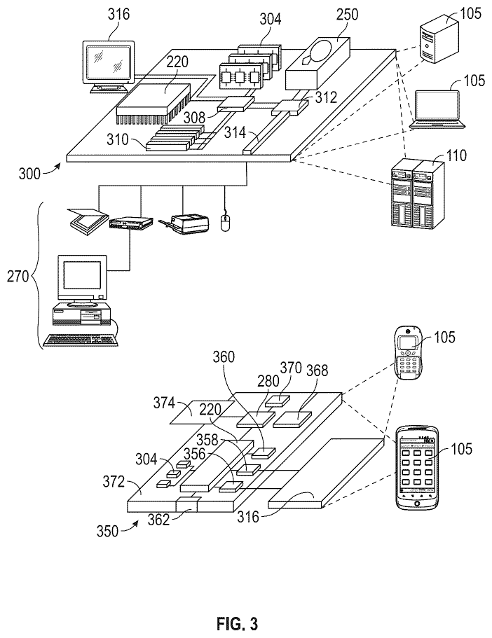

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers 110, databases 115, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various methods as described in greater detail below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer-readable medium, such as memory, expansion memory 374, or memory 304 on the processor 220 such as ROM 240, that may be received via the transceiver or external interface 362. The mobile computing device 350 may be implemented in a number of different forms, as shown in FIG. 3. For instance, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces, applications 605 run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), holographic displays, augmented reality displays, virtual reality displays, or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System (EMS), Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0), and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation- and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may comprise a power supply, which may be any source of power that provides the system 400 with the required energy. In a preferred embodiment, the power supply may be a stationary power source that has been installed in a way such that it is fastened in place, such as a 3-prong wall outlet. In a preferred embodiment, the stationary power source is connected to the wiring system of a premises. In another preferred embodiment, the power supply may be a mobile power source, such as a battery pack. In a preferred embodiment, mobile power source does not need to be connected to the wiring system of a premises to provide power to the system but may be capable of connecting to the wiring system of said premises to provide power to a system connected thereto. In another preferred embodiment, the system 400 may comprise multiple power supplies configured to supply power to the system 400 in different circumstances. For instance, the system 400 may be directly plugged into a stationary power source, which may provide power to the system 400 so long as the system does not move out of range of said stationary power source, as well as connected to a mobile power source, which may provide power to the system 400 when the system 400 is not connected to a stationary power source or in situations where the stationary power source ceases to provide power to the system 400.

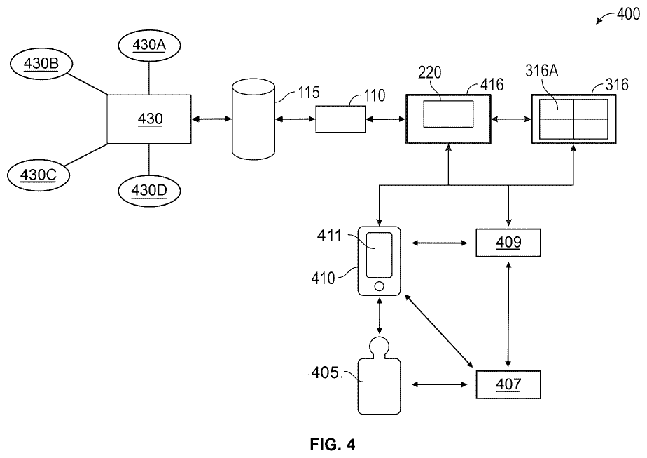

FIGS. 4-10 illustrate embodiments of a system 400 and methods for linking a computing device of a user 405 with a display of a food vendor in a way that allows a user to control said display of said food vendor. A user 405 preferably accesses the various applications 605 of a display 316 of a food vendor by inputting commands within a user interface 411 of a computing device 410 operably connected to the display 316, wherein said commands cause said computing device 410 to send a computer readable signal to said display 316 that may instruct a control board of the display as to what to present thereon. In a preferred embodiment, as illustrated in FIGS. 4-9, a user 405 may access said various applications 605 by using a user interface 411 of a computing device 410 to login to a user profile 430 having permissions that allow said user 405 to access the various applications 605 of the system 400. In a preferred embodiment a user may use the system to perform various functions, including, but not limited to, ordering food via said computing device of said user and/or said display of said food vendor, selecting display applications of said display and/or user applications of said computing device that may be presented on said display, transferring image data 430D of said user applications from said computing device to said display, and presenting said image data 430D of said display applications and/or user applications in a plurality of display windows of a display user interface of said display. In some preferred embodiments, the system 400 may identify the user 405 and/or determine a location of the user 405 within a premises of said food vendor. In yet another preferred embodiment, the system 400 may be configured to create custom advertisement groups based on user data 430A of said users 405, wherein said custom advertisement groups are preferably a form of programmatic advertising and/or advertisements pertaining to food products of the food vendor.

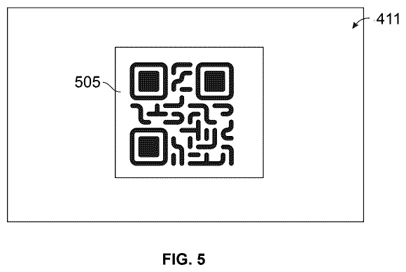

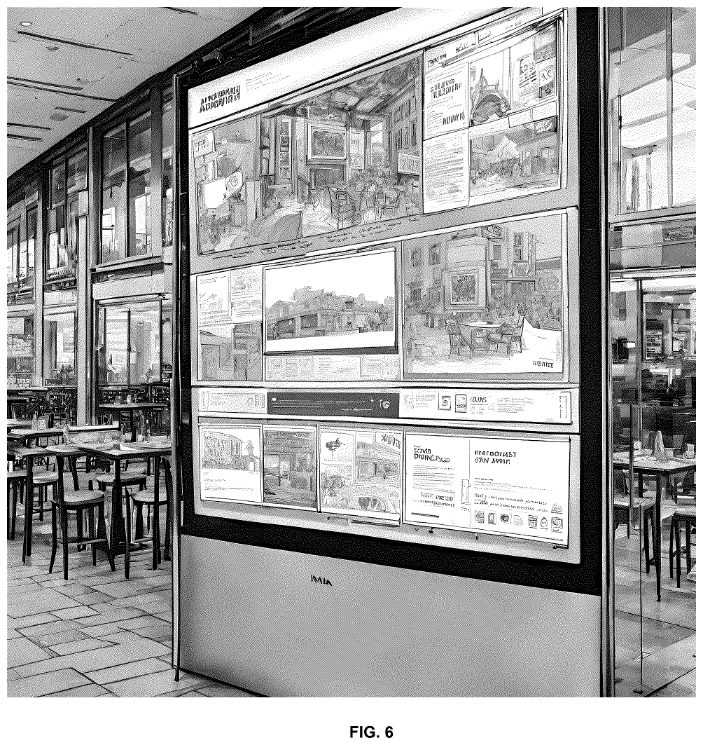

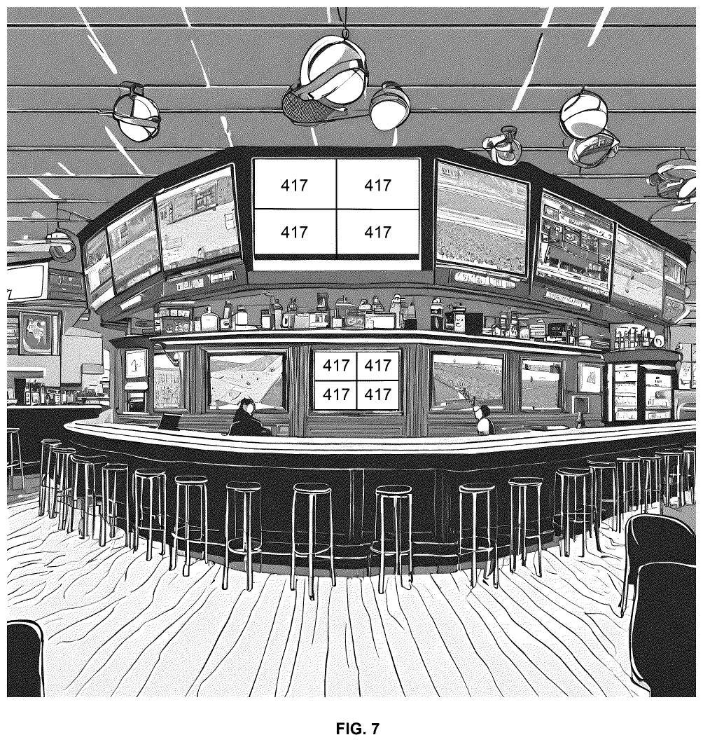

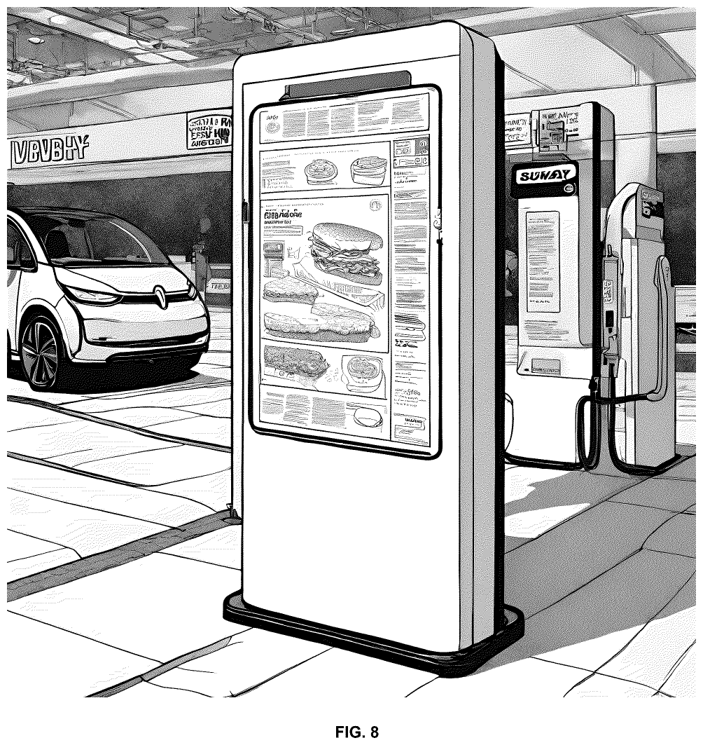

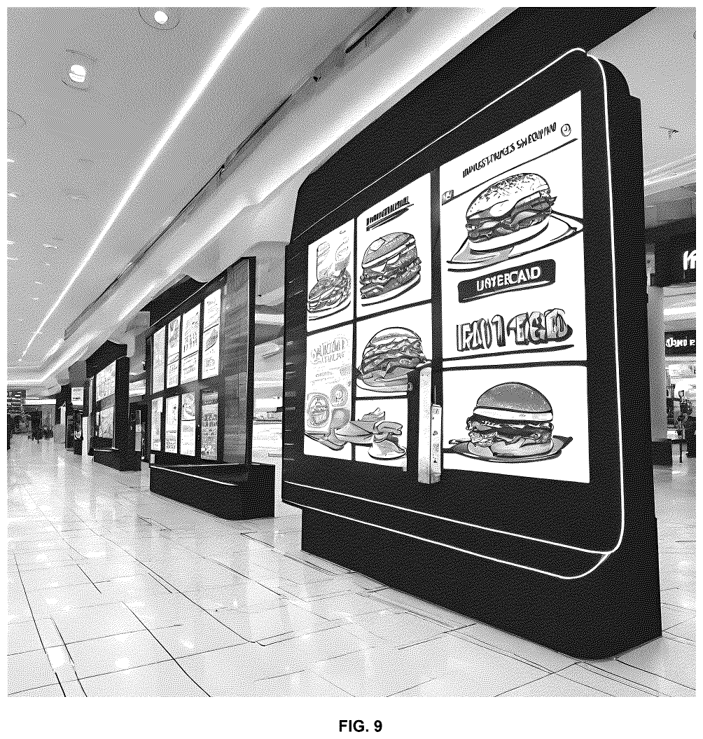

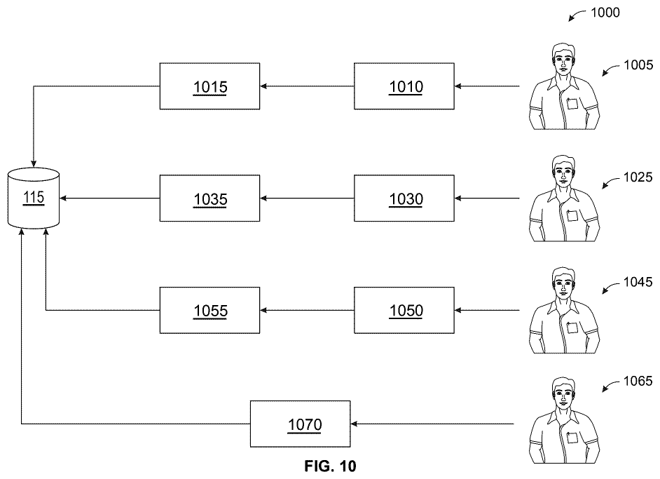

FIG. 4 illustrates a preferred embodiment of a system 400 having a computing device 410 and display 316 in fluid communication with one another, wherein a user interface of the computing device allows a user to manipulate said display of said food vendor. FIG. 5 illustrates a preferred embodiment of a display presenting a predefined pattern that may be used in a secondary security method used to identify a user and/or a location of a user on a premises of a food vendor. FIG. 6 is an environmental view illustrating a user manipulating an example display user interface of an exterior display, wherein the user is ordering food and watching user applications presented thereon. FIG. 7 is an environmental view illustrating a user manipulating an example display user interface of an interior display, wherein the user is ordering food and watching user applications presented thereon. FIG. 8 is an environmental view illustrating a user manipulating an example display user interface of a display of a charging/fueling station, wherein a control board 409 operably connected to said display 316 may receive a computer readable signal from the computing device 410 that may be transmitted to a food vendor associated with the charging/fueling station. FIG. 9 is an environmental view illustrating a user manipulating an example display user interface of a display of digital signage associated with a commercial premises having one or more food vendors, wherein a control board 409 operably connected to said display 316 may receive a computer readable signal from the computing device 410, which is subsequently transferred to said one or more food vendors. FIG. 10 illustrates permission levels 800 that may be utilized by the present system 400 for controlling access to user content 815, 835, 855 such as user data 430A, advertisement data 430B, display data 430C, image data 430D, and application data 430E. It is understood that the various method steps associated with any methods of the present disclosure may be carried out as operations by the system 400 shown in FIGS. 4-10.

The system 400 generally comprises one or more computing devices 410 having user interfaces 411, processor 220 operably connected to said one or more computing devices 410, display 316 operably connected to said processor 220, and non-transitory computer-readable medium (CRM) 416 coupled to said processor 220 and having instructions stored thereon. Some preferred embodiments may further comprise a camera 905 operably connected to said one or more computing device 410. In one preferred embodiment, a database 115 may be operably connected to the processor 220 and the various data of the system 400 may be stored therein, including, but not limited to, user data 430A, advertisement data 430B, display data 430C, image data 430D, and application data 430E. In some preferred embodiments, the display 316 may further comprise a display user interface 316A having a plurality of display windows configured to present the various data of the system 400 therein, wherein a control board 409 of the display 316 may be configured to receive said data and arrange it within the plurality of display windows. In yet another preferred embodiment, a wireless communication interface may allow the processors 220 of the system 400 to receive and transmit the various data of the system therebetween.

Though referred to as a single computing device 410 of a particular user 405, one with skill in the art will recognize that multiple computing devices 410 of multiple users may be used without departing from the inventive subject matter described herein. Additionally, though referred to as a single display, one with skill in the art will recognize that multiple displays may be linked together in a way that creates a “single” display that may be used in a manner without departing from the inventive subject matter described herein. For instance, four OLED televisions may be linked together in way that creates a multi-display that the system may use as a “single” display. Additionally, one with skill in the art will recognize that a plurality of displays may be controlled by a single control board, and the single control board may manage the plurality of display windows about the display user interfaces of the plurality of displays. In yet another preferred embodiment, two or more control boards of two or more displays may be operably connected to one another and manage the plurality of display windows about the display user interfaces of the plurality of displays in collaboration with one another. Accordingly, one with skill in the art will recognize that displays may be used in combination with one or more control boards and one or more computing devices in a number of ways without departing from the inventive subject matter described herein.

In a preferred embodiment, a control board 409 of the display 316 receives image data 430D from the computing entity 200. The control board 409 may then present said image data 430D via the display 316 in the display user interface 316A. In one preferred embodiment, the image data 430D is streamed from the computing entity 200 to the control board 409, wherein the control board 409 inserts said streamed image data 430D into the display user interface 316A. Alternatively, the control board 409 may manipulate the image data 430D and/or display user interface 316A based on commands received from an input device. In one preferred embodiment, the display user interface 316A may also comprise a control window, which may allow a user 405 to control the layout of the display user interface 316A. For instance, a user 405 may choose a layout that separates the display user interface 316A into multiple windows. Alternatively, an input device having a plurality of layouts thereon may be used to manipulate the layout of the display user interface 316A. The input device may be connected to the system 400 via a wired or wireless connection. In a preferred embodiment, the input device communicates sends a computer readable signal containing instructions to the control board 409, which the control board 409 uses to manipulate the image data 430D and/or display user interface 316A.

In a preferred embodiment, a user 405 logs into a user profile of the system before accessing the various features of a display, allowing the system to verify the identity of the user. A user interface 411 of a computing device 410 allows a user to input login credentials and/or commands. A processor 220 operably connected to said computing device and said display 316 sends the login credentials and/or commands to a control board of said display via a computer readable signal, wherein said login credentials and/or commands of said computer readable signal allow access to said display should they be associated with a user profile having sufficient permission levels. A user may then manipulate the user interface of the computing device in a way that allows said user to choose sporting events to be presented on the display. In some preferred embodiments, a user 405 may be required to use a secondary security method to access a display to order food and/or watch sporting events. For instance, a user 405 may be required to use a camera of their computing device 410 to scan a predefined pattern, such as a bar code or a QR code, that is presented on a display 316, as illustrated in FIG. 5, which may associate that user with a particular display. This may also serve as a means as determining a location of a user within a premises of a food vendor as display data of the display may relate the location of the display to the system.

In yet another preferred embodiment, a user may instruct the system 400 via the user interface to present content 815, 835, 855, wherein identifying information contained within user data 430A of a user profile of the user may assist the system 400 in locating that particular user within the premises of the food vendor. For instance, a customer may choose to watch a football game on a television amongst a plurality of televisions in a bar via the user interface 411 of their computing device 410. The system 400 may then use a camera 905 to collect image data 430D in order to identify the user and determine the location of the customer within the bar area. Once the customer and the location of the user has been determined, the system 400 may choose which screen will provide the best viewing experience for the customer and then transmit the football game to that display. In embodiments in which the system 400 creates and presents advertisement groups, the system 400 may use the camera 905 to determine which advertisements to present based on the proximity of the various users of the system.

In some preferred embodiments, the system 400 may further comprise a secondary security device. Devices that may act as the secondary security device may include, but are not limited to, biometric devices, key cards, wearables, or any combination thereof. In a preferred embodiment, devices that may act as the biometric devices include but are not limited to contact biometric devices, such as fingerprint scanners and hand geometry scanners, and/or non-contact biometric devices, such as face scanners, iris scanners, retina scanners, palm vein scanners, and voice identification devices. In some embodiments, the secondary security device may be operably connected to the computing device 410 and/or display 316 in a way such that it is in direct communication with the computing device 410 and/or display 316 and no other computing device 410 and/or display 316. For instance, the secondary security device in the form of a facial recognition camera may be securely and directly connected to a control board 409 of the display 316 such that a user 405 must biometrically scan their face prior to the system allowing access to food services of the system. In some preferred embodiments, biometric data associated with a user is saved in a user profile as user data, which the system uses to verify a user's identity. For instance, the secondary security device may be securely and directly connected to the computing device in a way such that a user 405 must biometrically scan a thumbprint prior to the system allowing a user to access a Point-of-Sale (POS) system that will allow the user to purchase a food product or access age restricted sporting events.

In a preferred embodiment, key cards and wearables preferably comprise a secure transmitter configured to transmit a login credentials to the computing device and/or control board of the display. Wearables having a secure transmitter include clothing and accessories, such as a T-shirt, pants, jacket, belt, shoes, wristband, watch, glasses, pin, nametag, etc., that has said transmitter attached thereto and/or incorporated therein. The secure transmitter preferably contains login credentials in the form of a unique ID, which may be conveyed to the computing device and/or control board of the display 316 in the form of a computer readable signal. Unique IDs contained within the computer readable signal that has been broadcast by the transmitter may include, but are not limited to, unique identifier codes, social security numbers, PINs, etc. For instance, a computer readable signal broadcast by a secondary security device in the form of a wrist band may contain information that will alert the control board of the display 316 that a particular user 405 is within a certain range, which may cause the system 400 to allow a user to order food or choose sporting events via their computing device and/or display if additional steps are taken.

Types of devices that may act as the transmitter include, but are not limited, to near field communication (NFC), Bluetooth, infrared (IR), radio-frequency communication (RFC), radio-frequency identification (RFID), and ANT+, or any combination thereof. In an embodiment, transmitters may broadcast signals of more than one type. For instance, a transmitter comprising an IR transmitter and RFID transmitter may broadcast IR signals and RFID signals. Alternatively, a transmitter may broadcast signals of only one type of signal. For instance, resort key cards may be fitted with transmitters that broadcast NFC signals containing unique IDs associated with a particular user, wherein displays equipped with NFC receivers must receive said NFC signals containing unique IDs before access to one or more features of the display user interface may be granted.

Use of secondary security devices may be used solely or in addition to secondary security methods of the system, allowing the system to have flexible multifactor identification to suit the needs of its environment. Simultaneous use may be beneficial for situations in which customers are allowed certain food options based on pre-purchased food plans, which is common on cruise ships, amusement parks, and resorts. A user may use a secondary security method to be associated with a certain display of the food vendor and alert the food vendor of a location of the user on their premises, and the wearable may instruct the system as to what food options a user may choose from before presenting said food options to the user via the display and/or computing device. The user may then use the display and/or computing device to order food and/or choose sporting events to watch. In some preferred embodiments, the transmitter may instruct the system as to which display applications and sporting events a user may access. For instance, a user may purchase a card containing a transmitter that grants the user access to every NFL game through the food vendor's system but not MLB games. After logging into the system, the user may scan the card to gain access to the NFL games but be unable to access the MLB games due to permission levels associated with the card. In some preferred embodiments, a user may also choose display applications or user applications to be presented on the display, wherein the various image data of the applications is organized within display windows of the display user interface.

In a preferred embodiment, the various data of the system 400 may be stored in user profiles 430. In a preferred embodiment, a user profile 430 is related to a particular user 405. A user 405 is preferably associated with a particular user profile 430 based on a username. However, it is understood that a user 405 may be associated with a user profile 430 using a variety of methods without departing from the inventive subject matter herein. Types of data that may be stored within user profiles 430 of the system 400 include, but are not limited to, user data 430A, advertisement data 430B, display data 430C, image data 430D, and application data 430E. Some preferred embodiments of the system 400 may comprise a database 115 operably connected to the processor 220. The database 115 may be configured to store user data 430A, advertisement data 430B, display data 430C, image data 430D, and application data 430E within said user profiles 430. As used herein, user data 430A may be defined as personal information of a user 405 that helps the system 400 identify the user 405 and their interests. Types of data that may be used by the system 400 as user data 430A includes, but is not limited to, a user's name, username, social security number, phone number, gender, age, movie preferences, television preferences, music preferences, extracurricular preferences, food preferences, food orders, or any combination thereof. As used herein, advertisement data 430B may be defined as data related to at least one public announcement design to promote a product, brand, service, or event. Types of data that may be used by the system 400 as advertisement data 430B includes, but is not limited to, image/audio files promoting a product, brand, service, or event. As used herein, display data 430C may be defined as data that may be used to identify a particular display 316 of the system 400. Display data 430C may include, but is not limited to, geolocation data, display name, display descriptions, or any combination thereof.

Image data 430C is used by the system in multiple ways. In one aspect, image data includes photographic or trace objects that represent the underlying pixel data of an area of an image element, which is created, collected, and stored using image constructor devices, such as a camera. The system may use image data obtained via a scanning device and/or a secondary security device to confirm the identity of a user. Image data of advertisements and/or sporting events may be transmitted to the display and presented to the user. Image data may be transmitted to the display from the computing device, server, and/or database to be presented within the plurality of display windows of the display. Accordingly, one with skill in the art will understand that image data 430C may be used by the system multiple ways to carry out various functions of the system without departing from the inventive subject matter described herein.

Application data may be defined as instructions that cause a display application of the display to perform an action. In one preferred embodiment, the system may determine whether a user application of the computing device is compatible with a display application of the display. If it is determined that the display application and user application are compatible, application data is transmitted to the display from the computing device in lieu of image data. The display application is run by the control board of the display and inserted into a display window, while instructions received from the computing device through the compatible user application are used by the control board to perform actions, reducing the amount of data transferred between the computing device and display. For instance, a Twitter display application and a Twitter user application may be compatible in a way such that a user may open the Twitter user application and select it via the user interface to be displayed in a display window of the display user interface. The control board may then determine if the Twitter display application is compatible with the Twitter user application. If the Twitter display application and Twitter user application are compatible, the control board may open the Twitter display application locally and manipulate it via commands received from the computing device of the user as actions are taken via the Twitter user application. If the Twitter display application and Twitter user application are not compatible, the control board may receive image data of the Twitter user application and present it within a display window of the display user interface.

When a user orders food using the system, user data in the form of a food order is created by the system. Types of information that may be included in a food order includes, but is not limited to, order location, food products purchased, purchase amount, or any combination thereof. Preferably, before the retrieval of image data associated with a sporting event is retrieved by the system, a user must order food via the user interface of the computing device and/or display user interface of the display. Once a user has made a food order, the system may allow a user to choose one or more sporting events to present via the display, causing the system to retrieve image data associated with the desired sporting event and insert it into a display window. In some preferred embodiments, an order value threshold may dictate what sporting events a user may view through the system. For instance, the system may determine that a table must order a minimum of $50 worth of food before they receive permission to view a particular sporting event.

As previously mentioned, some preferred embodiments of the display 316 may further comprise a control board 409. The control board 409 comprises at least one circuit and microchip. In another preferred embodiment, the control board 409 may further comprise a wireless communication interface, which may allow the control board 409 to receive instructions from an input device controlled by a user 405. In a preferred embodiment, the control board 409 may control the plurality of display windows of the display user interface 316A as well as the advertisement data 430B and image data 430D displayed therein. The microchip of the control board 409 comprises a microprocessor and memory. In another preferred embodiment, the microchip may further comprise a wireless communication interface in the form of an antenna. The microprocessor may be defined as a multipurpose, clock driven, register based, digital-integrated circuit which accepts binary data as input, processes it according to instructions stored in its memory, and provides results as output. In a preferred embodiment, the microprocessor may receive image data 430D of a sporting event and advertisement data 430B from a server 110 and/or database 115 via the wireless communication interface, wherein the advertisement data 430B and sporting event comprise image data 430D in the form of a video.

As mentioned previously, the system 400 may comprise a user interface 411. A user interface 411 may be defined as a space where interactions between a user 405 and the system 400 may take place. In an embodiment, the interactions may take place in a way such that a user 405 may control the operations of the system 400. A user interface 411 may include, but is not limited to operating systems, command line user interfaces, conversational interfaces, web-based user interfaces, zooming user interfaces, touch screens, task-based user interfaces, touch user interfaces, text-based user interfaces, intelligent user interfaces, brain-computer interfaces (BCIs), and graphical user interfaces, or any combination thereof. The system 400 may present data of the user interface 411 to the user 405 via a display 316 operably connected to the processor 220. A display 316 may be defined as an output device that communicates data that may include, but is not limited to, visual, auditory, cutaneous, kinesthetic, olfactory, and gustatory, or any combination thereof.

In a preferred embodiment, the control board 409 of the display 316 receives advertisement data 430B and image data 430D from the computing device, server 110, and/or database 115 and may then present said advertisement data 430B and/or image data 430D via at least one display window of the display user interface 316A of a display 316 of a food vendor, as illustrated in FIGS. 4-9. In a preferred embodiment, the advertisement data 430B and/or image data 430D are streamed/mirrored from the computing device, database 115, and/or server 110 to the control board 409, wherein the control board 409 inserts said streamed/mirrored advertisement data 430B and/or image data 430D into said at least one display window. Alternatively, the control board 409 may automatically select a layout of the display user interface 316A, wherein said layout may be determined based on a plurality of variables, including, but not limited to, number of users, type of content 815, 835, 855 being viewed by the user(s) 405, user preferences, user location, or any combination thereof. For instance, as illustrated in FIG. 6, the control board 409 may select a layout of a display user interface 316A comprising a split screen having two display windows configured to present two separate advertisements (a first targeted advertisement 1105 and second targeted advertisement 1205) targeting two separate users viewing the same content 815, 835, 855 presented via an application 605 of the display 316, wherein the users 405 were identified via their respective computing devices (a first computing device and a second computing device).

Information presented via a display 316 may be referred to as a soft copy of the information because the information exists electronically and is presented for a temporary period of time. Information stored on the non-transitory computer-readable medium 416 may be referred to as the hard copy of the information. For instance, a display 316 may present a soft copy of visual information via a liquid crystal display (LCD), wherein the hardcopy of the visual information is stored on a local hard drive. For instance, a display 316 may present a soft copy of audio information via a speaker, wherein the hard copy of the audio information is stored in RAM. For instance, a display 316 may present a soft copy of tactile information via a haptic suit, wherein the hard copy of the tactile information is stored within a database 115. Displays 316 may include, but are not limited to, cathode ray tube monitors, LCD monitors, light emitting diode (LED) monitors, gas plasma monitors, screen readers, speech synthesizers, haptic feedback equipment, virtual reality headsets, speakers, and scent generating devices, or any combination thereof.

The database 115 may be operably connected to the processor 220 via wired or wireless connection. In a preferred embodiment, the database 115 is configured to store user data 430A, advertisement data 430B, display data 430C, image data 430D, and application data 430E within user profiles 430. Alternatively, the user data 430A, advertisement data 430B, display data 430C, image data 430D, and application data 430E may be stored within user profiles 430 on the non-transitory computer-readable medium 416. The database 115 may be a relational database such that the user data 430A, advertisement data 430B, display data 430C, image data 430D, and application data 430E associated with each user profile 430 within the plurality of user profiles 430 may be stored, at least in part, in one or more tables. Alternatively, the database 115 may be an object database such that user data 430A, advertisement data 430B, display data 430C, image data 430D, and application data 430E associated with each user profile 430 of the plurality of user profiles 430 may be stored, at least in part, as objects. In some instances, the database 115 may comprise a relational and/or object database and a server 110 dedicated solely to managing the user data 430A, advertisement data 430B, display data 430C, image data 430D, and application data 430E in the manners disclosed herein.

As previously mentioned, some embodiments of the system 400 may determine the location of users 405 within a premises of a food vendor in order to more accurately determine which users 405 are viewing which displays 316. In a preferred embodiment, when a user follows a secondary security method described herein and scans a predefined pattern of a display, the user is associated with the display by the system. Additionally, the location of the user may be associated with the location of the display by the system. In another preferred embodiment, this may be accomplished via an indoor positioning system (IPS). The IPS may be configured to locate the user by using radio waves, magnetic fields, acoustic signals, or other sensory information that may be output by a wireless communication device of a user's computing device 410. In one embodiment, the IPS may use trilateration and triangulation methods to determine the location of a user's computing device 410 within a premises of a food vendor and subsequently determine what targeted advertising should be presented on which display 316. An IPS may determine the position of a user's computing device 410 using methods including, but not limited to, locator nodes 407, magnetic positioning, and dead reckoning, or any combination thereof. As described herein, locator nodes 407 are devices having known positions within the premises of the food vendor. In an embodiment, a wireless communication device may act as a locator node 407. A user's computing device 410 may be connected to the IPS in a way such that the system 400 may monitor the location of the user's computing device 410 when in range, which the system 400 may then use to estimate/confirm a user's location.

As illustrated in FIGS. 8 and 9, displays of fueling/charging stations and digital signage of commercial buildings may be manipulated by a user of the system via the computing device in a way that allows a user to order food from a food vendor associated with said fueling/charging station or commercial building. For instance, a user fueling or charging their vehicle may use the display of the pump/charger to purchase food while their vehicle fuels/charges. For instance, a user may access a display application of the display via a secondary security method using a computing device, which may allow the user to purchase food while they shop. This may reduce lines at food vendors located in such establishments as well as increase efficiency by reducing the need for employees to take orders of customers. In a preferred embodiment, the display of the charging station and/or digital signage of the commercial building may also present advertisement data to a user as they use the system to order food, which may be presented to the user via at least one of the display windows of the display user interface. In some embodiments, the display 316 of the charging station 600 may be used to present entertainment to the user 405 in addition to targeted advertising in order to promote attentiveness of the user 405 to the display 316. The system 400 may determine which entertainment to present to the user 405 based on the user data 430A. For instance, a user 405 having a user profile 430 indicating that the user 405 enjoys sports may present entertainment in the form of video clips of a sporting event to encourage attention of the user 405. Between the video clips, the display 316 may present targeted advertisements to the user 405, which may also be determined by the system 400 using the user data 430A within the user profile 430 of the user 405.

In a preferred embodiment, the system 400 may use artificial intelligence (AI) techniques to perform functions of the system. In one preferred embodiment, AI techniques may be used to control the number of display windows presented within the display user interface. In another preferred embodiment, AI techniques may be used to determine which advertisements should be presented to a user based on user data of the user profile of the user. In yet another preferred embodiment, AI techniques may be used to organize the plurality of display windows within the display user interface. In yet another preferred embodiment, AI techniques may be used by the system to determine a food order of a user. The term “artificial intelligence” and grammatical equivalents thereof are used herein to mean an intelligence method used by the system 400 to correctly interpret and learn from data of the system 400 or a plurality of systems in order to achieve specific goals and tasks through flexible adaptation. Types of intelligence methods that may be used by the system 400 include, but are not limited to, machine learning, neural network, computer vision, or any combination thereof.

The system 400 preferably uses machine learning techniques to perform the methods disclosed herein, wherein the instructions carried out by the processor 220 for said machine learning techniques are stored on the non-transitory computer-readable medium 416, server 110, and/or database 115. Machine learning techniques that may be used by the system 400 include, but are not limited to, classification algorithms, neural network algorithm, regression algorithms, decision tree algorithms, clustering algorithms, genetic algorithms, supervised learning algorithms, semi-supervised learning algorithms, unsupervised learning algorithms, deep learning algorithms, or other types of algorithms. More specifically, machine learning algorithms can include implementations of one or more of the following algorithms: support vector machine, decision tree, nearest neighbor algorithm, random forest, ridge regression, Lasso algorithm, k-means clustering algorithm, boosting algorithm, spectral clustering algorithm, mean shift clustering algorithm, non-negative matrix factorization algorithm, elastic net algorithm, Bayesian classifier algorithm, RANSAC algorithm, orthogonal matching pursuit algorithm, bootstrap aggregating, temporal difference learning, backpropagation, online machine learning, Q-learning, stochastic gradient descent, least squares regression, logistic regression, ordinary least squares regression (OLSR), linear regression, stepwise regression, multivariate adaptive regression splines (MARS), locally estimated scatterplot smoothing (LOESS) ensemble methods, clustering algorithms, centroid based algorithms, principal component analysis (PCA), singular value decomposition, independent component analysis, k nearest neighbors (kNN), learning vector quantization (LVQ), self-organizing map (SOM), locally weighted learning (LWL), apriori algorithms, eclat algorithms, regularization algorithms, ridge regression, least absolute shrinkage and selection operator (LASSO), elastic net, classification and regression tree (CART), iterative dichotomiser 3 (ID3), C4.5 and C5.0, chi-squared automatic interaction detection (CHAID), decision stump, M5, conditional decision trees, least-angle regression (LARS), naive bayes, gaussian naïve bayes, multinomial naïve bayes, averaged one-dependence estimators (AODE), bayesian belief network (BBN), bayesian network (BN), k-medians, expectation maximisation (EM), hierarchical clustering, perceptron back-propagation, hopfield network, radial basis function network (RBFN), deep boltzmann machine (DBM), deep belief networks (DBN), convolutional neural network (CNN), stacked auto-encoders, principal component regression (PCR), partial least squares regression (PLSR), sammon mapping, multidimensional scaling (MDS), projection pursuit, linear discriminant analysis (LDA), mixture discriminant analysis (MDA), quadratic discriminant analysis (QDA), flexible discriminant analysis (FDA), bootstrapped aggregation (bagging), adaboost, stacked generalization (blending), gradient boosting machines (GBM), gradient boosted regression trees (GBRT), random forest, or even algorithms yet to be invented.

In a preferred embodiment, the system may determine food that a user wishes to order using a machine learning technique. For instance, the system may obtain audio data from a user and process it using natural language processing (NLP) to discern what food a user would like to order. In a preferred embodiment, advertisements presented to a user based on user data contained within the user profile of the user. In some preferred embodiments, the system 400 may use machine learning techniques to create advertisement groups for a plurality of users 405 using a single display 316. For instance, if the system 400 determines that at least two users 405 have very different political interests but enjoy similar extracurricular activities, the system 400 may create an advertisement block that avoids political advertisements in favor of said extracurricular activities. For instance, if the system 400 determines that at least one user 405 is a child, the system 400 may prevent the display 316 of advertisements that might be deemed too mature for said child despite adult users being within the vicinity. The system 400 may also take into account what media content 815, 835, 855 is being presented via the display 316 before creating/presenting an advertisement block. For instance, if a user 405 is watching a particular sporting event, the system 400 may choose at least one advertisement of an advertisement block that pertains to the sport associated with the sporting event.

In multiple preferred embodiments, the system 400 applies AI techniques to facilitate the control of the displayed menu by a food vendor employee or a patron. In one preferred embodiment, the system 400 records user data 430 in the form of food orders and suggests further food items that it determines would be of interest to the patron. For instance, the system 400 might apply machine learning techniques to compare purchase histories at the vendor and identify items frequently purchased together, reducing the need for staff to manually remember and suggest pairings. This not only increases efficiency but also potentially boosts sales by presenting relevant options to customers at the point of decision. Accordingly, a user ordering a hamburger may be prompted by the display 316 to purchase French fries. In a preferred embodiment, the system 400 can adapt to seasonal changes in the menu or availability of ingredients. As new items are introduced or existing ones modified, the system might quickly incorporate these changes into its recommendation algorithm, ensuring that suggestions remain relevant and up-to-date.

In a preferred embodiment, the AI-powered recommendations create a more tailored and enjoyable dining experience. By analyzing individual purchase histories and aggregating data across all customers, the system can offer suggestions that align with personal preferences while also introducing new items that have been popular among similar diners. This personalization extends beyond simple item pairings to include sophisticated flavor profile matching. Food vendors may identify the primary flavors in the foods and beverages they serve and submit it as a data set for training AI in conjunction with user purchase histories. The AI then uses these data sets to construct flavor profiles of each food, beverage, or ingredient and identify popular and unpopular pairings. Furthermore, when the system 400 creates a comprehensive flavor map of the menu, the AI may be enabled to suggest pairings based not just on popularity or frequency of co-purchase, but on actual flavor compatibility. Thus, when a user identifies their desired food order, the AI could suggest a food or beverage pairing with flavors that have been specified by the vendor or by previous orders as compatible. For example, a user that orders a ribeye steak might receive a recommendation to pair it with new potatoes and a glass of Merlot. In another preferred embodiment, the system 400 may record as user data 430 the flavor profiles of items previously purchased by a specific user. For example, the system might recognize that a particular customer frequently orders dishes with bold, spicy flavors. When that customer orders a main course, the AI could recommend side dishes or beverages that complement or balance those flavor preferences. This level of customization can lead to higher customer satisfaction and potentially encourage patrons to explore new menu items they might not have considered otherwise.

By suggesting complementary sides and beverages, the AI helps patrons build a well-rounded meal that enhances the overall dining experience. This not only improves customer satisfaction but can also increase the average order value for the food vendor. In a preferred embodiment, in addition to enhancing the dining experience and potentially increasing sales, the user data 430 collected by the system 400 can also provide valuable insights to food vendors about customer preferences and trending flavor combinations. This data 430 can inform menu development, inventory management, and marketing strategies, allowing vendors to continually refine their offerings to meet customer demands and preferences.

In a preferred embodiment, the system 400 utilizes AI techniques to add information about food preparation and status to the display 316 to enhance the user experience. For instance, a user 405 with an allergy, intolerance, or dietary restriction forbidding a particular ingredient or class of ingredients might request to see all menu items complying with their requirements. Alternatively, a user restricting their food intake to a certain caloric threshold might specify that their combined purchase display the summed calorie count. This feature could be further expanded to include detailed ingredient lists or nutritional information for each menu item, enabling users to make more informed decisions about their food choices. In another preferred embodiment, the system 400 is capable of interfacing with one or more fitness tracking applications to provide a seamless experience for those monitoring their daily caloric intake. Such an embodiment might incorporate the food items and their caloric value automatically into the fitness tracking application upon the user 405 connecting their personal computing device 410 to the system 400. In yet another preferred embodiment, the nutritional tracking functionality herein described is extended to include other nutritional metrics such as macronutrient breakdowns or vitamin content.

In a preferred embodiment, the system 400 comprising a microphone uses NLP techniques to detect the language spoken by a user or a group of users and display a translated menu among the display windows. Such a capability for menu translation addresses the needs of a diverse customer base, potentially increasing accessibility for tourists or in multilingual communities. In another preferred embodiment, this feature is enhanced to include cultural explanations of unfamiliar dishes or ingredients, further improving the dining experience for international customers. In yet another preferred embodiment, the system 400 uses machine learning techniques to display a projected wait time or cook time based on the food items ordered, the number of food preparation employees, and the number of food orders currently pending. Additionally, the system 400 could use this data to suggest optimal ordering times to customers, helping to balance kitchen workload and reduce peak-time congestion. The food vendor may likewise use these data to assess staffing requirements at different points during the day, week, or year.

In another preferred embodiment, the system 400 uses machine learning techniques to estimate changes in wait time based on allergy or dietary restrictions. For instance, a user with a gluten allergy may need the food preparation employees to thoroughly clean a space to prevent cross-contamination, resulting in increased wait times for food. This feature could be further developed to include a prioritization system for allergy-safe food preparation, ensuring that these orders are handled with appropriate care and attention. The system could also provide staff with automated reminders and checklists for allergy-safe food handling procedures on a display 316 in the food preparation area, further enhancing safety measures.

In several preferred embodiments, the system 400 is operated upon by a display 316 or computing device 410 in the kitchen or food preparation area to provide real-time updates and menu information to one or more displays or users. In one preferred embodiment, the employees responsible for food preparation update the menu based on ingredient availability. For instance, upon running out of ground beef, a restaurant employee might update the system to flag foods requiring ground beef as unavailable. In another example, exhaustion of prepared dishes for which ingredients still exist (e.g., exhaustion of cooked meatloaf while the food vendor still has every meatloaf ingredient) might cause that dish to be flagged as delayed while the employees prepare the dish from its component ingredients. In another preferred embodiment, AI techniques are used to extrapolate one or more data points based on information about ingredient availability. For instance, a restaurant cook might not have time to individually sift through the menu and flag food as unavailable based on the shortage of one ingredient. In such an instance, AI could save time by removing or flagging all relevant dishes upon the input “out of eggs.” In a preferred embodiment, if the AI determines based on vendor input that the ingredient is optional, the menu item might be flagged as available but missing said optional ingredient for the customer (e.g., a burrito item on the menu might be flagged as “no cilantro.”) By allowing food preparation employees to update the menu based on ingredient availability, the system ensures that customers are always presented with accurate information about what can be ordered. This real-time updating prevents customer disappointment and reduces the workload on front-of-house staff who would otherwise need to communicate these changes manually.

In yet another preferred embodiment, the food preparation employees provide updates to the system 400 regarding the status and progress of a particular food order, which is then relayed to displays 316 utilized by food service employees and customers. This feature provides transparency to customers about potential wait times and allows kitchen staff to prioritize the preparation of these items. It also offers an opportunity for customers to make informed decisions about their orders, potentially choosing alternative dishes if they are pressed for time. In still another preferred embodiment, the system 400 comprising a camera or microphone utilizes one or more machine learning techniques to detect information about the progress of a food item from the speech of the food preparation employees or the image data of a food staging area. In a preferred embodiment, the system 400 may use more than one machine learning technique to determine which advertisements may be most appealing to a user 405 based on their user data 430A within their user profile 430 pertaining to advertisement seen by the user. For instance, the system 400 comprising a microphone may use a combination of NLP and reinforcement learning to discern which advertisements that a user 405 finds more humorous and/or which products a user 405 has verbally expressed interest in. If the system 400 determines that a user 405 is showing less interest in a particular advertisement, the system 400 may create a new advertisement block using advertisements that the system 400 has determined the user 405 is currently showing greater interest. In another preferred embodiment, the system 400 may actively monitor a user's attention to a currently presented sporting event and recommend alternative sporting events to a user if it is determined the user is losing interest in a currently presented sporting event. For instance, the system 400 comprising a camera may use a combination of facial emotion recognition (FER) and deep learning to discern interest of a user 405 in a sporting event before recommending alternative sporting events to a user.

In a preferred embodiment, the machine learning techniques comprise instructions configured to create a trained machine learning techniques from at least some training data and according to an implementation of the machine learning techniques, wherein the training data serves as a baseline dataset that may act as the foundational data of the machine learning techniques. The instructions of the machine learning techniques dictate how the machine learning techniques gain knowledge from the various data sources of the system and may comprise various types of programable instructions that include, but are not limited to, local commands, remote commands, executable files, protocol commands, selected commands, or any combination thereof. The instructions of the machine learning techniques may vary widely, depending on a desired implementation. In a preferred embodiment, instructions may include streamed-lined instructions that instruct the machine learning techniques on how to train the system, possibly in the form of a script (e.g., Python, Ruby, JavaScript, etc.). In another preferred embodiment, the instructions may include data filters or data selection criteria that define requirements for desired results sets created from the various data of the system as well as which machine learning algorithm is to be used.

Training of the machine learning techniques may be supervised, semi-supervised, or unsupervised. In some preferred embodiments, the machine learning systems may use NLP to analyze data (e.g., audio data, text data, etc.). For instance, the system may use audio data of a user to determine if a user desires dessert and present an advertisement for desserts of a type said user has historically favored. The historically favored desserts may be derived by machine learning techniques by analyzing user data of said user related to desserts. Training of the machine learning techniques may result in baseline machine learning techniques that may serve as AI techniques for performing the various of the system in the manners described herein.

Baseline machine learning techniques may further be configured to act as passive models or active models. A passive model may be described as a final, completed machine learning model that uses only the baseline data set to establish behavior of the baseline machine learning technique. An active model may be described as a plasticity machine learning model that is dynamic in that it may be updated using both the baseline dataset and data outside of the baseline data set.

In a preferred embodiment, the system may use a passive model to allow for a high degree of control as to how the system manages user interfaces and display windows in the manners described herein. For instance, a passive model may be configured via a private dataset to provide each user of the system with the same food and/or sporting event recommendations. These recommendations may be made by the system regardless of user data that may indicate that particular users have historically preferred other food products and/or sporting events. However, a passive model may be especially useful for users having user profiles with little user data from which the machine learning techniques may learn from. In some preferred embodiments, the system may be configured to begin as passive models until a threshold amount of user data has been acquired. Once the threshold amount of user data has been acquired, the system may cause the machine learning techniques to switch to active models, allowing the system to make recommendations to a user that better parallel historical preferences of the user. For instance, a system may be configured to recommend MLB games instead of NFL games during the month October via a passive machine model until a user has chosen 10 sporting events to watch via the system. Once the user has chosen to watch 10 sporting events, the machine learning techniques of the system may switch to an active machine model for that particular user and recommend sporting events as determined by the active machine model.

In some embodiments, an active machine model may be updated in real-time, daily, weekly, bimonthly, monthly, quarterly, or annually using the various data (e.g., to update model instructions, shifts in time, new/corrected private data sets, user data, etc.), of the system. In some preferred embodiments, the passive machine model may also be updated as new/updated private data sets become available. In a preferred embodiment, machine learning techniques comprise metadata that describe the state of the passive/active model with respect to its updates. The metadata may include attributes describing one or more of the following: a version number, date updated, amount of new data used for the update, shifts in model parameters, convergence requirements, or other information. Because each user of the system may potentially have a unique machine learning technique associated with their user profile due to the personal nature of user data associated with each user profile, such information allows for identifying distinct passive/active models within the system that may be separately managed.

To prevent un-authorized users from accessing other user's information, the system 400 may employ a security method. As illustrated in FIG. 10, the security method of the system 400 may comprise a plurality of permission levels 800 that may grant users 405 access to user content 815, 835, 855 within the database while simultaneously denying users 405 without appropriate permission levels 800 the ability to view user content 815, 835, 855. To access the user content 815, 835, 855 stored within the database 115, users 405 may be required to make a request via a user interface 411. Access to the data within the database 115 may be granted or denied by the processor 220 based on verification of a requesting user's 805, 825, 845 permission level 800. If the requesting user's 805, 825, 845 permission level 800 is sufficient, the processor 220 may provide the requesting user 805, 825, 845 access to user content 815, 835, 855 stored within the database. Conversely, if the requesting user's 805, 825, 845 permission level 800 is insufficient, the processor 220 may deny the requesting user 805, 825, 845 access to user content 815, 835, 855 stored within the database. In an embodiment, permission levels 800 may be based on user roles 810, 830, 850 and administrator roles 870, as illustrated in FIG. 10. User roles 810, 830, 850 allow requesting users 805, 825, 845 to access user content 815, 835, 855 that a user 405 has uploaded and/or otherwise obtained through use of the system 400. Administrator roles 870 allow administrators 865 to access system 400 wide data.

In an embodiment, user roles 810, 830, 850 may be assigned to a user 405 in a way such that a requesting user 805, 825, 845 may view user profiles 430 containing user data 430A, advertisement data 430B, display data 430C, image data 430D, and application data 430E via a user interface 411. To access the data within the database 115, a user 405 may make a user request via the user interface 411 to the processor 220. In an embodiment, the processor 220 may grant or deny the request based on the permission level 800 associated with the requesting user 805, 825, 845. Only users 405 having appropriate user roles 810, 830, 850 or administrator roles 870 may access the data within the user profiles 430. For instance, as illustrated in FIG. 10, requesting user 1 805 has permission to view user 1 content 815 and user 2 content 835 whereas requesting user 2 825 only has permission to view user 2 content 835. Alternatively, user content 815, 835, 855 may be restricted in a way such that a user may only view a limited amount of user content 815, 835, 855. For instance, requesting user 3 845 may be granted a permission level 800 that only allows them to view user 3 content 855 related to their specific interest but not user 3 content 855 related to the identity of said user 405. In the example illustrated in FIG. 10, an administrator 865 may bestow a new permission level 800 on users 405 so that it may grant them greater permissions or lesser permissions. For instance, an administrator 865 may bestow a greater permission level 800 on other users 405 so that they may view user 3's content 855 and/or any other user's content 815, 835, 855. Therefore, the permission levels 800 of the system 400 may be assigned to users 405 in various ways without departing from the inventive subject matter described herein.

The subject matter described herein may be embodied in systems, apparati, methods, and/or articles depending on the desired configuration. In particular, the various implementations of the subject matter described herein may be realized in digital electronic circuitry, integrated circuitry, specially designed application-specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, devices, and arrangements of the parts and method stages which have been described and illustrated in order to explain the nature of this inventive subject matter can be made without departing from the principles and scope of the inventive subject matter.

What is claimed is:

1. A system for controlling content presented on displays of food vendors, comprising:
a control board configured to manipulate a plurality of display windows of a display user interface;
a computing device having a user interface and operably connected to said control board,
wherein a user accesses a user profile via said user interface of said control board,
wherein said computing device transmits a permission level of said user profile to said control board,
wherein said permission level instructs said control board as to which content said user has permission to present via said display;
a display operably connected to said computing device and said control board,
wherein said display is configured to present said display user interface having said plurality of display windows,
wherein said control board manipulates said plurality of display windows of said display user interface presented on said display,
wherein said content is presented within said plurality of display windows;
a non-transitory computer-readable medium coupled to said processor,
wherein said non-transitory computer-readable medium contains instructions stored thereon, which, when executed by said processor, cause said processor to perform operations comprising:
transmitting said permission level of said user profile to said control board;
determining which said content said user has access to based on said permission level,
presenting accessible content to said user via said user interface,
transmitting at least one content choice of said user to said control board,
receiving a food order from at least one of said display user interface or said user interface;
presenting image data associated with said at least one content choice on said display in response to receiving the food order,
wherein said at least one content choice is presented within said plurality of display windows;
manipulating, via a machine learning technique, said plurality of display windows within said display user interface based on user data.

2. The system of claim 1, further comprising a secondary security device configured to verify an identity of said user.

3. The system of claim 2, further comprising additional instructions, which, when executed by said processor, cause said processor to perform additional operations comprising:
verifying said identity of said user using information obtained by said secondary security device,
determining food recommendations for said user based on said user data when said identity if verified,
presenting, via said display, said food recommendations to said user.

4. The system of claim 1, further comprising additional instructions, which, when executed by said processor, cause said processor to perform additional operations comprising:
transmitting a selection of a user application to said control board,
wherein said selection of said user application is made by said user via said user interface of said computing device;
determining whether said permission level allows said user to present said user application; and
transmitting application data from said computing device to said control board, wherein said control board presents said application data within said plurality of display windows.

5. The system of claim 1, further comprising a database operably connected to the processor,
wherein the database is configured to store user data, advertisement data, display data, image data, and application data within a plurality of user profiles.

6. The system of claim 5, further comprising additional instructions, which, when executed by said processor, cause said processor to perform additional operations comprising:
creating an advertisement group for a plurality of users, via a machine learning technique, based on said user data contained within said user profiles of said plurality of users,
wherein said machine learning technique analyzes said user data or said plurality of user to identify common interests among said plurality of users,
wherein said machine learning technique pairs said common interests of said plurality of users with advertisement data related to said common interests; and
presenting said advertisement data associated with said advertisement group on said display.

7. The system of claim 1, further comprising additional instructions, which, when executed by said processor, cause said processor to perform additional operations comprising:
dynamically adjusting, via said machine learning technique, a size and position of said plurality of display windows based on a real-time analysis said content presented within said plurality of display windows.

8. The system of claim 1, further comprising a camera operably connected to said processor,
wherein said camera is configured to capture image data of said user,
wherein said machine learning technique analyzes said image data to determine user engagement with said content that is being presented within said plurality of display windows.

9. The system of claim 8, further comprising additional instructions, which, when executed by said processor, cause said processor to perform additional operations comprising:
receiving said image data from said camera,
determining, via said machine learning technique, said user engagement with said content by analyzing said image data.

10. The system of claim 9, further comprising additional instructions, which, when executed by said processor, cause said processor to perform additional operations comprising:
dynamically adjusting, via said machine learning technique, a size and position of said plurality of display windows based on said user engagement.

11. A method for controlling content presented on displays of food vendors, comprising:
transmitting, via a processor, a permission level of a user profile of a user to a control board,
wherein said permission level instructs said control board as to which content said user has permission to access via a display,
wherein said control board is configured to control a plurality of display windows of a display user interface,
wherein said display user interface having said plurality of display windows is presented via said display;
determining, via said control board, which said content said user has access to based on said permission level,
presenting accessible content to said user via at least one of said user interface or said display user interface,
transmitting at least one content choice of said user to said control board,
receiving a food order from at least one of said display user interface or said user interface;
presenting, via said display, image data associated with said at least one content choice in response to receiving the food order,
wherein said at least one content choice is presented within said plurality of display windows;
manipulating, via a machine learning technique, said plurality of display windows within said display user interface based on user data.

12. The method of claim 11, further comprising additional steps of:
verifying an identity of the user using information obtained from a secondary security device.

13. The method of claim 12, further comprising additional steps of:
determining food recommendations for said user based on said user data when said identity is verified; and
presenting, via said display, said food recommendations to said user.

14. The method of claim 11, further comprising additional steps of:
transmitting a selection of a user application to said control board,
wherein said selection of said user application is made by said user via said user interface of said computing device;
determining whether said permission level allows said user to present said user application; and
transmitting application data from the computing device to the control board,
wherein said control board presents said application data within the plurality of display windows.

15. The method of claim 11, further comprising additional steps of:
storing user data, advertisement data, display data, image data, and application data within a plurality of user profiles in a database operably connected to a processor.

16. The method of claim 15, further comprising additional steps of:
creating an advertisement group for a plurality of users, via a machine learning technique, based on said user data contained within said user profiles of said plurality of users,
wherein said machine learning technique analyzes said user data of said plurality of users to identify common interests among said plurality of users,
wherein said machine learning technique pairs said common interests of said plurality of users with said advertisement data related to said common interests; and
presenting said advertisement data associated with said advertisement group on said display.

17. The method of claim 11, further comprising steps of:
dynamically adjusting, via a machine learning technique, a size and position of said plurality of display windows based on a real-time analysis of said content presented within said plurality of display windows.

18. The method of claim 11, further comprising steps of:
receiving image data of said user from a camera,
analyzing, by a machine learning technique, said image data to determine user engagement with said content that is being presented within said plurality of display windows.
dynamically adjusting, via the machine learning technique, a size and position of the plurality of display windows based on the user engagement.

19. A non-transitory computer readable medium containing instructions configured to control content presented on displays of food vendors, comprising:
a non-transitory computer-readable medium coupled to a processor,
wherein said non-transitory computer-readable medium contains instructions stored thereon, which, when executed by said processor, cause said processor to perform operations comprising:
transmitting a permission level of a user profile of a user to a control board,
wherein said user profile is accessed by a user via a user interface of a computing device operably connected to said control board,
wherein said permission level instructs said control board as to which content said user has permission to access via a display,
wherein said control board is configured to control a plurality of display windows of a display user interface,
wherein said display user interface having said plurality of display windows is presented via said display;
determining which said content said user has access to based on said permission level,
presenting, via at least one of said user interface and or said display user interface, accessible content to said user,
transmitting at least one content choice of said user to said control board,
wherein said content choice is made by said user via at least one of said user interface and or said display user interface,
wherein said content choice is said accessible content selected by said user,
receiving a food order from at least one of said display user interface or said user interface;
presenting, via said display, image data associated with said at least one content choice in response to receiving the food order,
wherein said at least one content choice is presented within said plurality of display windows;
dynamically adjusting, via a machine learning technique, a size and a position of said plurality of display windows based on a real-time analysis of said content presented within said plurality of display windows.

20. The method of claim 19, further comprising additional instructions, which, when executed by said processor, cause said processor to perform additional operations comprising:
receiving image data of said user from a camera,
analyzing, by a machine learning technique, said image data to determine user engagement with said content that is being presented within said plurality of display windows.
dynamically adjusting, via said machine learning technique, said size and said position of said plurality of display windows based on said user engagement.
